(19) United States
(12) Patent Application Publication
(10) Pub. No.: US 2015/0113099 A1
(43) Pub. Date: Apr. 23, 2015

(54) METHOD AND DEVICE FOR MAKING AVAILABLE A CONTENT, STORED ON A SERVER IN ENERGY STANDBY MODE

(71) Applicant: SAGEMCOM BROADBAND SAS, Rueil-Malmasion (FR)

(72) Inventors: Eric Masera, Rueil-Malmaison (FR); Frédéric Bone, Rueil-Malmaison (FR)

(73) Assignee: SAGEMCOM BROADBAND SAS, Rueil-Malmaison (FR)

(21) Appl. No.: 14/367,469

(22) PCT Filed: Dec. 18, 2012
(86) PCT No.: PCT/EP2012/075896

§ 371 Date: Jul. 30, 2014

(30) Foreign Application Priority Data
Dec. 20, 2011 (FR) 11/62009

(51) Int. Cl. H04L 29/08

(52) U.S. Cl. CPC H04L 67/16; H04L 67/1097
USPC 709/219

(57) ABSTRACT

A method for making stored content. A server (aggregator) presents to an item of equipment contents that are stored, each content being accessible to the item of equipment on the basis of information stored by the aggregator (original reference), which identifies the server by which this content is stored and which enables accessing this content on the identified server. The aggregator stores, for each content stored by a server in a server network, information (local reference), associate with the original reference of this content. The original reference, which is associated with a local reference present in a content request sent by an item of equipment and received by the aggregator, is obtained. This server is awakened by the aggregator, by sending a wake-up message intended for the server that stores the content associated with the obtained original reference. The aggregator sends, to the item of equipment, the obtained original reference.

The present invention concerns a method for making available a content, stored by a server in energy standby mode.

Servers and equipment, in particular multimedia, at the present time communicate through communication networks thus enabling a user to access these contents without having to act directly on these servers.

The DLNA (Digital Living Network Alliance) standard, accessible on the internet site www.dlna.org, for example, offers interoperability between equipment of different manufacturers, so that functions of making available content on multimedia servers, reading content (content reader and display), or discovery and control of lists of equipment connected to the network and contents stored by these servers can be implemented, by control points of these networks.

In particular, the DLNA standard allows the deployment of a network distributed system in which it is necessary for each item of equipment to announce itself. This is because, as the DLNA standard is based on the UPnP (Universal Plug and Play) architecture accessible on the internet site www.upnp.org, for discovery and publication of services, any server carrying UPnP services that leaves the network has its services deleted from the lists managed by the control points of the network, either because a time limit occurs or because this server, when leaving the network, has generated a leaving message, related to UPnP or not, or because a message intended for this server does not receive any response. Once the server is disconnected, the system then loses any trace of existence of this server and the contents that it stores.

Continuity of distributed multimedia services is therefore based on the permanent availability of the servers, thus preventing any deep standby mode of these servers and involving high electrical consumption, even if the multimedia service is not used.

Approaches are known for however enabling a server to operate, meaning to respond to requests from remote machines in a temporary standby mode. The general principle of these approaches consists of putting on standby the most parts possible of a connected server, while keeping an active or partially active interface so that it is capable of receiving and analysing a signal intended to signify its awakening to this server. Such a method, called Wake on LAN (WoL) has been offered on an internet link for the administration of systems (AMD article “Magic Packet Technology” accessible on the website:

http:support.amd.comusEmbedded_TechDocs20213.pdf). It consists of sending an Ethernet packet with specific content containing the address of the machine of the system to be awakened.

Another solution, known by the name TwonkyServer (accessible on the website www.twonky.com) enables a server to present the content of other servers in the same sub-network. This solution presents contents to a user while masking the presence of the various servers by the use of an aggregator, which is merely one of the servers of the network that is responsible for presenting to the user its own contents but also those of other servers.

This role of aggregator is fulfilled by making either a copy of the contents or a copy of the references on the server designated as the aggregator.

The physical copy of the contents on the aggregator enables offering great availability to the contents but with great additional expense in terms of storage space, since the aggregator forms a mirror for all the other servers.

The role of aggregator may also be fulfilled by presenting to the user so-called original references of these contents. These original references enables identifying the servers in the network on which these contents are stored and enables accessing these contents on these servers thus identified. Aggregation of the references of the contents on the aggregator avoids copying the contents into the aggregator.

Such a referencing method follows DLNA standard operation, meaning the original references of the contents that are stored by servers disconnected from the network are deleted from the aggregator, either because these servers leave the network or because a time limit expires, or because these servers, when leaving the network, have generated a leaving message (linked to UPnP or not), or because a message intended for these servers does not receive any response.

This referencing method is therefore not suitable for servers operating in standby mode, since, in this case, their contents are no longer available.

The problem solved by the present invention is affording continuity of access to contents referenced and stored by servers in a network of servers, while allowing these servers to operate in standby.

To this end, in general terms, according to the present invention, an item of information, referred to as local reference, is associated with the original reference of each content liable to be made available to an item of equipment in this network. These local and original references are stored by one of the servers in this network, referred to as aggregator, which enables the servers that host the contents thus referenced to go on standby and to be awakened by another element in the network, which may be the aggregator itself, only when access to one of its contents is requested. To do so, an item of equipment makes a request for listing the content stored by all the servers connected to this network, as well as their associated local references. This list of contents may then be presented to a user of this equipment: each of these contents then being associated with an association between an original reference and a local reference, whatever the operating state of the servers (awakened or on standby).

When the user, having received a list of available contents emanating from the aggregator, requests a content, a request is formed that contains a local reference and the item of equipment sends this request to the aggregator.

This aggregator receives the request, from which it extracts the local reference of the content required, finds the original reference of this content from this local reference, awakens the server identified by this original reference and transmits the original reference to the item of equipment so that this item of equipment is redirected to the server that stores the requested content.

According to one of its aspects, the present invention concerns a method for making available a content stored by a server in a network of servers in which one of these servers, referred to as aggregator, presents to an item of equipment contents that are stored by servers in this network, each content being accessible to the item of equipment from information stored by the aggregator, referred to as original reference, which identifies the server on which this content is stored and which enables accessing this content on this server thus identified. The method is characterised in that it comprises the following steps:
storing, by the aggregator, for each content stored by a server in the network, information, referred to as local reference, in association with the original reference of this content,
obtaining, from the original references thus stored by the aggregator, the original reference that is associated with a local reference present in a content request sent by an item of equipment and received by the aggregator,
awakening this server by the aggregator, during which the aggregator sends a so-called wake-up message to the server that stores the content associated with the original reference thus obtained,
sending, by the aggregator to the item of equipment, the original reference thus obtained.

According to a variant of this method, the wake-up message is sent either directly to the server that stores the content associated with the original reference thus obtained, or to an entity in the network capable of, in its turn, sending a wake-up message to the server that stores the content associated with the original reference thus obtained.

According to a variant, the original reference thus obtained is sent by the aggregator to the item of equipment only once the server that stores the required content responds to the message sent by the aggregator during awakening.

It is advantageous that the original reference thus obtained be sent by the aggregator to the item of equipment only once the server that stores the required content responds to the message sent by the aggregator during awakening. Indeed, the method then ensures that the item of equipment that requested the content can access it since the server that stores it is no longer on standby.

According to a variant of this method, the storing step of the method is preceded by a step of discovery of the items of equipment on the network during which the items of equipment connected to the network, those that leave this network and those that are newly connected to this network, announce themselves to the other items of equipment in the network, the step of discovery of the items of equipment being followed by the storing step so that an association between the original reference of each multimedia content on each server thus discovered and a local reference is stored.

According to a variant of this method, the storing step of the method is preceded by a step of discovery of the services particular to the management of the energy states of the items of equipment in the network, during which it is established which of the servers have the ability to change operating mode when they are connected, and during which the methods of waking up each of these servers are stored by the aggregator or another item of equipment in the network responsible for the awakening, these waking-up methods then being used during the awakening step.

According to a variant of this embodiment, an association between the original reference of each multimedia content of a server thus discovered and a local reference is stored only if this server has the ability to change operating mode.

According to a variant of this embodiment, when a server connected to the network is awakened, an association between the original reference of each content stored by this server and a local reference is stored by the aggregator and the aggregator then sends a signal to this server indicating thereto that it can go on standby.

The invention also concerns a computer program that can be stored on a medium and/or downloaded from a communications network, in order to be read by a computer system or a processor. This computer system comprises instructions for implementing the method mentioned above, when said program is executed by the computer system or the processor. The invention also concerns storage means comprising such a computer program and a device comprising means for implementing the above method.

The features of the invention mentioned above, as well as others, will emerge more clearly from a reading of the following description of an example embodiment, said description being given in relation to the accompanying drawings, among which:

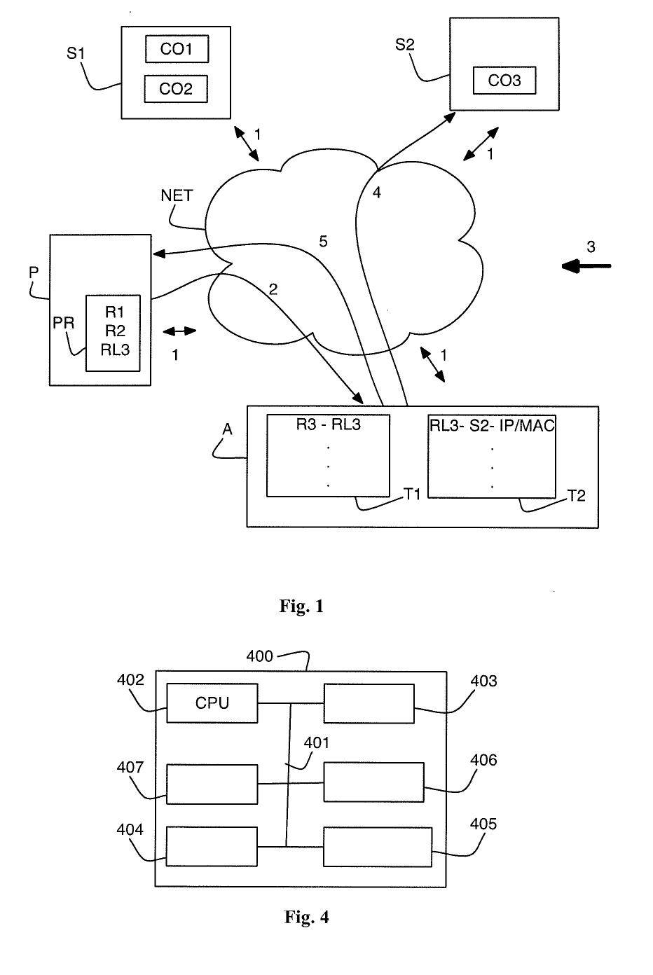

FIG. 1 shows an example of a diagram of a communication system that uses a method for making available content according to the present invention.

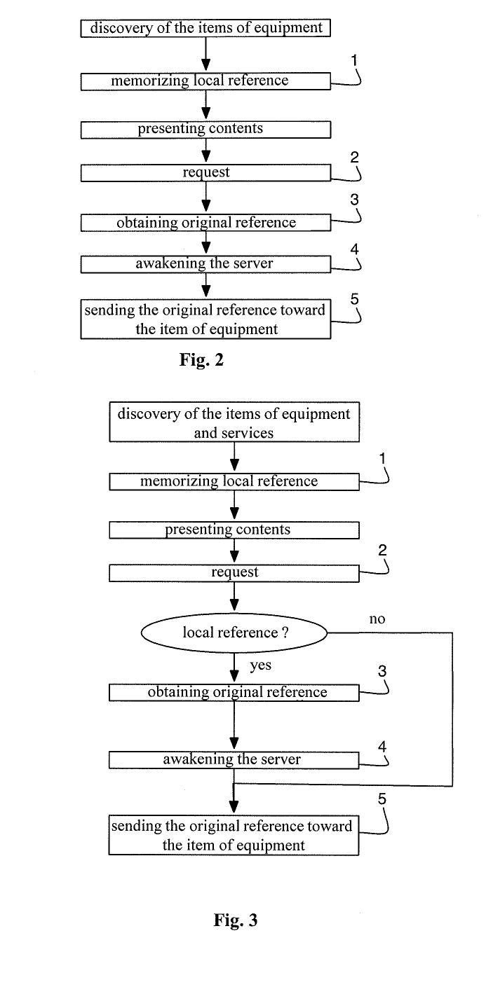

FIG. 2 shows a diagram of a variant of the method in FIG. 1.

FIG. 3 shows a diagram of another variant of the method in FIG. 1.

FIG. 4 schematically illustrates the architecture of a device that at least partially implements the method in FIG. 1.

According to the example in FIG. 1, the system comprises at least one multimedia content server, namely S1 and S2. The server Si stores multimedia contents CO1 and CO2, while the server S2 stores a multimedia content CO3.

The system also comprises an item of equipment P, typically an item of equipment used by a user for displaying a multimedia content, such as a computer or a smartphone. This item of equipment, in a mode involving UPnPDLNA, is a control point that can thus be hosted by any entity in the network, including any one of the servers, or the item of equipment used by the user for requesting a multimedia content stored by one of the servers S1 or S2.

The system also comprises a server A, which is hereinafter referred to as aggregator, for indicating that, in addition to being able to fulfill the conventional functions of a multimedia content server, it comprises particular means for implementing the present invention. Among these particular means, the aggregator A comprises means for presenting to a user the contents stored by the servers S1 and S2. When these contents are of the multimedia type, they are presented in the form, for example, of a list of titles of these contents or illustrations representing the jackets of these contents. Whatever its visual representation and the means used by the user to select a content from its visual representation, each visual representation, once selected, enables the aggregator A to know the original reference of this requested content.

The servers S1, S2, the aggregator A and the item of equipment P communicate with each other via a communications network NET or a wired or wireless local network.

This system is only one example given by way of illustration and in no way limits the scope of the invention, which extends to networks having more than two content servers, or plural items of equipment P, or to any type of network, local or not.

Information stored by the aggregator A, referred to as original reference, is associated with each content, which enables identifying the server on which this content is stored and enables accessing this content on this server thus identified. Thus an original reference R1 is associated with the content CO1, an original reference R2 with CO2 and an original reference R3 with CO3.

An original reference is, for example, a URL of the type protocol:addressIP_MDpath. In this example, protocol indicates the communication protocol used for accessing the content, addressIP_MD is the machine address or name, and optionally the port, of the server on which the content is stored, and path specifies the access on the server to the content.

The method for making available a multimedia content stored by a server, namely S2 in the network of servers NET, comprises a step 1 of storing, by the aggregator A, for each content stored by a server in the network, information, referred to as local reference, in association with the original reference of this content.

Thus, at the end of this step, the aggregator stores a local reference for each content stored by a same server. This implies that the contents stored by some servers in the network may not be associated with local references. For example, the content CO3, stored by the server S2, may be associated with a local reference RL3, then stored in association with the original reference R3, and the contents CO1 and CO2 stored by the server S1 are not associated with local references.

A local reference is, for example, a URL of the type protocol:addressIP_MLpath.aggregated. In this example, protocol indicates the communication protocol used for accessing the content, addressIP_ML indicates that the content is stored locally, path specifies the access on the server to the content, and .aggregated is a flag that enables distinguishing a local reference from an original reference.

Other examples for forming a local reference can be used without departing from the scope of the present invention. What is essential is that this local reference has a form or comprises an indicator (a flag) that enables the aggregator to distinguish it from an original reference.

According to one example, the associations between the original references and the local references are stored in a table T1, illustrated in FIG. 1, and the associations between local references and the IP and MAC addresses of the servers S1 and S2 are stored in a table T2. The tables T1 and T2 may optionally be combined with each other in order to form only a single table.

Each content stored by servers is thus associated with its original reference and a local reference. Thus, when an item of equipment makes a request for listing the contents available to the aggregator, the aggregator sends it the list of contents stored by all the servers connected to this network as well as their associated local references. This list of contents can then be presented to a user of this item of equipment. This user can then request one of these contents, for example the content CO3. The request, which then comprises the local reference relating to this required content, namely RL3, is sent by the item of equipment P to the aggregator A (step 2).

The method then continues with a step 3 of obtaining from amongst the original references stored by the aggregator A the original reference, namely R3, which is associated with the local reference RL3.

The method continues with a step 4 of awakening this server by the aggregator A, during which the aggregator sends a so-called wake-up message to the server that stores the content associated with the original reference thus obtained. According to a variant, this wake-up message is sent directly to the server that stores the content associated with the original reference thus obtained and, according to another variant, this wake-up message is sent to an entity in the network capable of, in its turn, sending a wake-up message to the server that stores the content associated with the original reference thus obtained. According to one embodiment of this awakening step, a so-called wake-up packet, such as the “Ethernet magic packet” of the protocol called Wake On LAN (WOL), is sent in order to wake up the server that stores the required content. To do so, the aggregator A recovers the IP and/or MAC address of this server from the table T2 thus referenced by the local reference associated with the required content. The awakening step is followed by a step 5 of sending, by the aggregator A to the item of equipment P, the original reference R3 thus obtained.

To do so, the method HTTP REDIRECT standardised by the organisation W3C in the document RFC2616 entitled “Hypertext Transfer Protocol—HTTP/1.1” can be used. This method indeed enables, in general terms, during a request by an item of equipment to one entity, to redirect this item of equipment toward another entity.

The item of equipment P then considers this original reference R3 and is thus redirected to the server S2, which stores the required content CO3. According to one embodiment, the original reference is sent by the aggregator A to the item of equipment P following the awakening step.

Advantageously, the original reference is sent by the aggregator A to the item of equipment P only once the server that stores the required content responds to a message sent by the aggregator following the awakening step. For example, following the awakening step during which a wake-up packet has been sent, a command PING (ICMP echo request) is sent by the aggregator A and a response ICMP echo reply from the server is awaited by the aggregator in order to indicate thereto that this server is indeed awakened.

FIGS. 2 and 3 show diagrams of two variants of the method illustrated in FIG. 1 in the case where the UPnPDLNA standards (Internet site www.upnp.org and www.dlna.org) are implemented on the various items of equipment and servers in the network NET in order to offer specific services such as the discovery of the items of equipment connected to the network NET or the management of the energy states of the items of equipment in this network. According to these standards, at least one control point PC is present in the network. This control point PC may be hosted by the aggregator A or by any other item of equipment then in relationship with the item of equipment P and the aggregator A, including a server in this network. It will be considered hereinafter that the control point PC is hosted by the aggregator A and we shall speak only of the aggregator A. However, it is obvious to a person skilled in the art that this control point PC may be offset on another entity and then communicate with the aggregator A without departing from the scope of the invention.

FIG. 2 shows a diagram of a first variant of the method in FIG. 1. According to this first variant, the storing step 1 of the method is preceded by a step of discovery of the various items of equipment in the network, such as the item of equipment P and the servers S1 and S2. The discovery of the items of equipment connected to the network NET enables each item of equipment in this network to announce itself to the other items of equipment in the network, either periodically or as soon as this item of equipment is newly connected to this network or when it leaves this network. Thus, from this indication, the aggregator A continuously knows the servers that are connected to the network.

This discovery step is implemented for example by the control point PC.

During the storing step, each server discovered is then parsed in order to establish a list of the content that it stores and an association is then stored between the original reference of each content of each server thus discovered and a local reference.

Thus, when an item of equipment makes a request for listing the contents available to the aggregator from the item of equipment P, the aggregator A sends thereto the list of contents stored by all the servers connected to this network as well as their associated local references. This list of contents may then be presented to a user of this item of equipment P: each of these contents then being associated with an association between an original reference and a local reference, whatever the operating state of these servers (awakened or on standby).

When the user requests a content through the item of equipment P, for example CO3, a request is made that contains a local reference, namely RL3, and the item of equipment P sends this request to the aggregator.

The method then continues with the step 3 of obtaining, from the original references stored by the aggregator A, the original reference that is associated with a local reference present in a content request sent by the item of equipment P and received by the aggregator A. The obtaining step then continues with the awakening step 4 as previously described. The awakening step continues with the step of sending, by the aggregator A to the item of equipment P, the original reference thus obtained.

FIG. 3 shows a diagram of another variant of the method in FIG. 1. According to this variant, the storing step 1 of the method is preceded by a step of discovery of the services particular to the management of the energy states of the items of equipment in the network. The signalling at the middleware level of the energy states of the items of equipment of a network has been dealt with by various standardisation groups. In particular, the UPnP Forum (www.upnp.org) defined UPnP Low Power, a set of services and commands for, remotely, knowing and modifying the standby states.

To summarize, this type of service consists of each item of equipment connected to the network signalling to the other items of equipment, including the aggregator A, its changes in state (awakened/standby) so that knowledge of each of the items of equipment connected to the network concerning the other items of equipment connected to this network is updated. Thus the aggregator A, or another item of equipment in the network responsible for the awakening, continuously knows whether each server in the network is awakened or on standby and consequently whether each server has the ability to change operating mode (awakened/on standby).

During this service discovery step, the aggregator, or another item of equipment in the network responsible for the awakening, also obtains the methods for awakening the servers and stores these awakening methods, which are then used during the step of awakening the servers.

Preferably, the steps of discovery of the items of equipment and services particular to the management of the energy states of these items of equipment are performed in parallel.

During the storing step 1, each server connected to the network is parsed in order to establish a list of contents that it stores and an association is stored between the original reference of each multimedia content of a server thus discovered and a local reference only if this server has the ability to change operating mode, meaning the ability to switch from a standby mode to an awakened mode and vice versa.

According to the example in FIG. 1, the server S2 has the ability to change operating mode and the server S1 has not. In this case, only the association between RL3 and R3 is stored in the table T1 and the IP and/or MAC addresses of the server S2 are stored in the table T2 in relation to RL3.

Indeed, in the case where a server does not have this ability to switch from an awakened mode to a standby mode and vice versa, it is unnecessary to store an association between local and original references since all the contents stored by these servers are directly accessible to the item of equipment P.

Thus, each multimedia content that is presented to the user is associated either with its original reference if this server has not indicated that it has the ability to change operating mode, or with an association between its original reference and a local reference if this server has indicated that it has the ability to change operating mode. When the user requires one of these contents, the request then comprises either an original reference, thus indicating that the server is awakened, or a local reference, thus indicating that the server is on standby.

According to a variant of the storage step, when a server connected to the network NET is awakened, an association between the original reference of each content stored by this server and a local reference is stored by the aggregator A and the aggregator then sends a signal to this server indicating thereto that it can go on standby. The UPnP Low Power signalling may be used for this purpose.

This variant enables minimising the energy consumption of the servers in the network.

When the aggregator A receives a request, the method then continues with a step of testing the content of this request.

If the request comprises an original reference, then the method continues with the step of sending, by the aggregator A to the item of equipment P, the original reference thus obtained. This item of equipment can then access the required content since the server that stores it is not on standby.

If the request comprises a local reference, the method then continues with the step 3 of obtaining the original reference followed by the awakening step 4 during which the server is awakened using the or one of its awakening methods stored by the aggregator A. The step 4 is followed by the step 5 of sending the original reference to the item of equipment P as described above. Only from this time the item of equipment P can then access the required content because the server that stores it is not on standby.

FIG. 4 schematically illustrates the architecture of a device that at least partially implements the method in FIG. 1.

The device 400 comprises, connected by a communication bus 401:
a processor, microprocessor, microcontroller (denoted μc) or CPU (central processing unit) 402;
a volatile memory (random access memory) 403;
a non-volatile memory (read only memory) 404;
a storage medium reader 405, such as an SD card (secure digital card) reader;
means 406 for interfacing with the communication network NET, such as for example a cellular radiotelephony network, Internet or WiFi network; and
man-machine interface means 407 for managing for example a touch screen and/or a set of keys.

The microcontroller 402 is capable of executing instructions loaded in the memory 403 from the memory 404, an external memory (not shown), a storage medium, such as an SD card or the like, or a communications network. When the device 400 is powered up, the microcontroller 402 is capable of reading instructions from the memory 403 and executing them. These instructions form a computer program that causes the microcontroller 402 to implement all or some of the algorithms described above in relation to FIGS. 1, 2 and 3.

All or some of the algorithms described below in relation to FIGS. 1, 2 and 3 can be implemented in software form by the execution of a set of instructions by a programmable machine, such as a DSP (digital signal processor), a CPU or an SoC device, or a microcontroller, such as the microcontroller 402, or be implemented in hardware form by a machine or dedicated component, such as an FPGA (field-programmable gate array) or an ASIC (application-specific integrated circuit).

1. A method for making available a content stored by a server in a network of servers in which one of these servers, referred to as aggregator, presents to an item of equipment a list of available contents stored by said servers, each content being accessible to the item of equipment from information stored by the aggregator, referred to as original reference, which identifies the server on which said content is stored,
wherein said aggregator, at the same time as presenting to said item of equipment the list of contents available, presents information, referred to as local reference, on certain contents, which said aggregator previously stored in association with the original reference of the corresponding content,
and wherein the method further comprises the following steps implemented following the sending via the item of equipment of a request for a content identified by a local reference and reception thereof by said aggregator:
obtaining, by said aggregator, the original reference that is associated with the local reference present in said request,
awakening, by the aggregator, the server identified by the original reference thus obtained by sending a so-called wake-up message to said server, and
sending, by the aggregator to the item of equipment, the original reference thus obtained so that said item of equipment can obtain said required content from said server.

2. The method according to claim 1, wherein the wake-up message is sent either directly to the server by which the content associated with the original reference thus obtained is stored, or to an entity other than the network capable of, in its turn, sending a wake-up message to said server by which the content associated with the original reference thus obtained is stored.

3. The method according to claim 1, wherein the original reference thus obtained is sent by the aggregator to the item of equipment after the server by which the required content is stored has responded to the wake-up message sent by said aggregator.

4. The method according to claim 1, wherein said method comprises a step of discovery of the items of equipment in the network during which the items of equipment connected to the network, those that leave this network and those that are newly connected to this network, announce themselves to the other items of equipment in the network, followed by a step of storing the original reference and the associated local reference, if any, of each content available on each server thus discovered.

5. The method according to claim 4, wherein said method further comprises a step of discovery of the services particular to the management of the energy states of the items of equipment in the network, during which it is established which of the servers have the ability to change operating mode when they are connected, followed by a step of associating a local reference with the original reference of the contents stored by said servers for storage thereof in association by said aggregator.

6. The method according to claim 5, wherein, during said services discovery step, methods for awakening each of the servers that have the ability to change operating mode when they are connected are stored by the aggregator, or by another item of equipment in the network responsible for the awakening, these awakening methods then being used during said awakening step.

7. The method according to claim 5, wherein said method comprises an associating step during which, when a server connected to the network is awakened and wishes to go on standby, a local reference is associated with the original reference of the contents stored by said server for storage by said aggregator of said references in association, said aggregator then sending a signal to said server indicating thereto that it can go on standby.

8. A device for making available a content stored by a server in a network of servers in which one of these servers, referred to as aggregator, presents to at least one item of equipment a list of available contents stored by servers, said aggregator comprising a memory in which, at each content accessible to each item of equipment, information is stored, referred to as original reference, which identifies the server by which said content is stored,
wherein, in the memory of said aggregator, information is also stored, referred to as local reference, in association with the original reference of contents of servers,
and in that said aggregator further comprises:
means for obtaining the original reference that is associated with a local reference present in a content request sent by an item of equipment and received by said aggregator,
means for awakening the server identified by the original reference thus obtained by said obtaining means by sending a so-called wake-up message to said server, and
means for sending, to the item of equipment, the original reference thus obtained by said obtaining means so that said item of equipment can obtain said required content from said server.

9. (canceled)

10. Storage means storing a computer program comprising instructions for implementing, by an aggregator, the method according to claim 1, when said program is executed by a processor of said aggregator.
